(19) United States
(12) Patent Application Publication
(10) Pub. No.: US 2023/0207170 A1
(43) Pub. Date: Jun. 29, 2023

(54) MAGNETIC PARTICLE AND MAGNETIC COMPONENT

(71) Applicant: SAMSUNG ELECTRO-MECHANICS CO., LTD., Suwon-si (KR)

(72) Inventors: Jong Ok JEON, Suwon-si (KR); Hyo Ki HONG, Suwon-si (KR); Jeong Ho LIM, Suwon-si (KR); Il Jin PARK, Suwon-si (KR); Young Seuck YOO, Suwon-si (KR); In Young KANG, Suwon-si (KR)

(73) Assignee: SAMSUNG ELECTRO-MECHANICS CO., LTD., Suwon-si (KR)

(21) Appl. No.: 18/085,229

(22) Filed: Dec. 20, 2022

(30) Foreign Application Priority Data
Dec. 28, 2021 (KR) 10-2021-0189221
Nov. 8, 2022 (KR) 10-2022-0147687

(51) Int. Cl. H01F 1/34; H01F 27/255; B22F 1/16; B22F 1/08; B22F 1/054; B22F 1/05

(52) U.S. Cl. CPC H01F 1/344; H01F 27/255; B22F 1/16; B22F 1/08; B22F 1/054; B22F 1/05; H01F 27/28

(57) ABSTRACT

A magnetic particle includes a magnetic metal particle having a plurality of phases. The plurality of phases include an Fe-based phase and an Fe₃O₄ phase. An area ratio of the Fe₃O₄ phase in which the Fe₃O₄ phase occupies in the plurality of phases is less than 50%.

### CROSS-REFERENCE TO RELATED APPLICATION(S)

This application claims benefit of priority to Korean Patent Application No. 10-2021-0189221 filed on Dec. 28, 2021 and Korean Patent Application No. 10-2022-0147687 filed on Nov. 8, 2022 in the Korean Intellectual Property Office, the disclosures of which are incorporated herein by reference in their entireties.

### TECHNICAL FIELD

The present disclosure relates to a magnetic particle and a magnetic component.

### BACKGROUND

In a magnetic component such as an inductor, a common mode filter, an LC filter, a balun, a magnetic recording medium, or the like, a magnetic particle is generally included in a body to realize intended magnetic properties. In this case, the magnetic particle may be formed of a ferrite-based magnetic material, a metal-based magnetic material, or the like.

In a magnetic component, in order to realize low resistance, a high DC bias characteristic, a high efficiency characteristic, or the like, it is necessary to refine the magnetic particle and increase a packing density of the magnetic particle while reducing loss thereof. However, with the trend for miniaturization of magnetic components, a size of the body may also be miniaturized, and accordingly, there may be a limit to increasing amounts of magnetic particles that may be included in the body. In addition, when the body is formed with a high pressure in order to increase the packing density of the magnetic particle, there may be problems such as deformation of the magnetic component. Accordingly, there is a need for a method for minimizing loss of magnetic components by improving properties of the magnetic particle.

### SUMMARY

An aspect of the present disclosure is to realize a magnetic particle in which a loss characteristic of a magnetic component is improved.

As a method for solving the above problem, the present disclosure intends to propose a novel magnetic particle through an example, and specifically, the magnetic particle includes a magnetic metal particle having a plurality of phases. The plurality of phases include an Fe-based phase and an Fe₃O₄ phase. An area ratio of the Fe₃O₄ phase in which the Fe₃O₄ phase occupies in the plurality of phases is less than 50%.

According to another aspect of the present disclosure, a magnetic particle includes a magnetic metal particle having a plurality of phases. The plurality of phases include an Fe-based phase and an Fe₃O₄ phase. A ratio of the Fe₃O₄ phase present on a surface of the magnetic metal particle is less than 70%.

According to another aspect of the present disclosure, a magnetic particle includes a magnetic metal particle having a plurality of phases. The plurality of phases include an amorphous phase and an Fe₃O₄ phase.

According to another aspect of the present disclosure, a magnetic component includes a body containing a plurality of magnetic particles. At least one magnetic particle, among the plurality of magnetic particles, includes a magnetic metal particle having a plurality of phases. The plurality of phases include an Fe-based phase and an Fe₃O₄ phase, wherein an area ratio of the Fe₃O₄ phase in which the Fe₃O₄ phase occupies in the plurality of phases is less than 50%.

According to another aspect of the present disclosure, a magnetic component includes a body containing a plurality of magnetic particles. The plurality of magnetic particles include first to third magnetic particles including first to third magnetic metal particles, respectively. The first magnetic particle has a diameter in a first diameter range, the second magnetic particle has a diameter in a second diameter range, smaller than the first diameter range, and the third magnetic particle has a diameter in a third diameter range, smaller than the second diameter range, and the third magnetic metal particle includes an Fe-based phase and an Fe₃O₄ phase.

According to another aspect of the present disclosure, a magnetic particle includes a magnetic metal particle containing Fe and having a plurality of phases, and an oxide film containing Fe to cover the magnetic metal particle.

### BRIEF DESCRIPTION OF DRAWINGS

The above and other aspects, features, and advantages of the present disclosure will be more clearly understood from the following detailed description, taken in conjunction with the accompanying drawings.

FIGS. 1A and 1B illustrate a magnetic particle according to an embodiment of the present disclosure. FIGS. 1A and 1B correspond to a transmission perspective view and a cross-sectional view, respectively.

FIGS. 2 to 5 illustrate magnetic particles according to modified embodiments.

FIG. 6 is a schematic transparent perspective view illustrating a magnetic component according to an embodiment of the present disclosure.

FIG. 7 is a schematic cross-sectional view of the magnetic component of FIG. 6, taken along line I-I′.

FIGS. 8 and 9 are enlarged views of a region of a body in the magnetic component of FIG. 6.

FIG. 10 illustrates the magnetic particles of FIG. 9.

FIGS. 11 to 15 illustrate a magnetic component having a wound coil structure.

### DETAILED DESCRIPTION

Hereinafter, embodiments of the present disclosure will be described with reference to specific embodiments and the accompanying drawings. Embodiments of the present disclosure may be modified in various other forms, and the scope of the present disclosure is not limited to embodiments described below. Further, embodiments of the present disclosure may be provided in order to more completely explain the present disclosure to those skilled in the art. Accordingly, shapes and sizes of components in the drawings may be exaggerated for clearer description, and components indicated by the same reference numerals in the drawings may be the same elements.

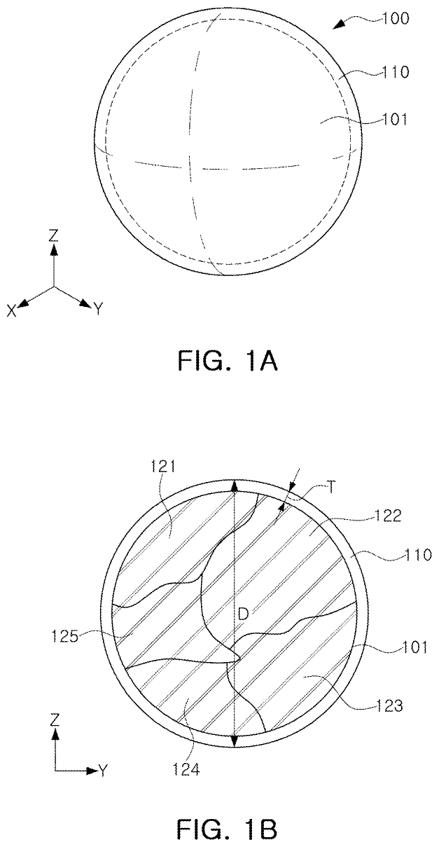

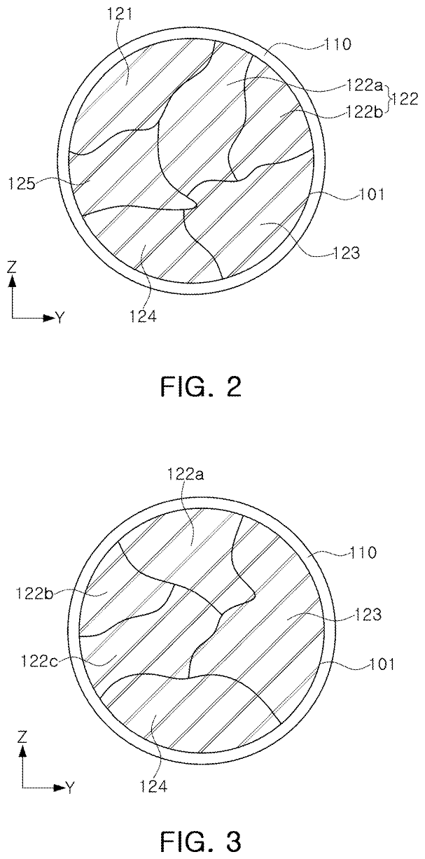

FIGS. 1A and 1B illustrate a magnetic particle according to an embodiment of the present disclosure. FIGS. 1A and 1B correspond to a transmission perspective view and a cross-sectional view, respectively. FIGS. 2 to 4 illustrate cross-sectional views of magnetic particles according to modified examples.

Referring to FIGS. 1A and 1B, in the present embodiment, a magnetic particle 100 may include a magnetic metal particle 101 having a plurality of phases 121 to 125. Also, the magnetic particle 100 may include an oxide film 110 formed on a surface of the magnetic metal particle 101. The plurality of phases 121 to 125 included in the magnetic metal particle 101 may include an Fe-based phase 122 and an Fe₃O₄ phase 123 to 125. In this case, among the plurality of phases 121 to 125, an amount ratio (e.g., an area ratio) occupied by the Fe₃O₄ phases 123 to 125 may be less than 50%. For example, amounts (e.g., areas) of the Fe₃O₄ phases 123 to 125 may be less than a sum of amounts (e.g., areas) of remaining phases 121 and 122. In the magnetic metal particle 101 constituting the magnetic particle 100, both the Fe-based phase 122 and the Fe₃O₄ phase 123 to 125 may be included, while relative amounts (e.g., areas) of these may be adjusted as in the following embodiment. Therefore, coercive force of the magnetic particle 100 may be effectively lowered. As above, when the magnetic particles 100 having such a lowered coercive force is used in a magnetic component, efficiency characteristics may be improved by reducing loss. In addition, the plurality of phases 121 to 125 may include an amorphous phase 121 as a partial phase. Hereinafter, main components of the magnetic particle 100 will be described in detail.

The Fe-based phase 122 of the magnetic metal particle 101 may include a material for securing magnetic properties, for example, at least one selected from the group consisting of iron (Fe), silicon (Si), chromium (Cr), cobalt (Co), molybdenum (Mo), aluminum (Al), niobium (Nb), copper (Cu), and nickel (Ni). Specifically, the Fe-based phase 122 may include a metal including Fe, Si, and Cr. As a more specific example, the Fe-based phase 122 may include at least one of pure iron, an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, or an Fe—Cr—Al-based alloy. For example, when the Fe-based phase 122 includes an Fe—Cr—Sr-based alloy, wt % of Si and Cr may be 15 w % or less, and as a more specific example, 0.80 wt %<Si<12.5 wt %, and 2.5 wt % %<Cr<14.2 wt %.

The Fe-based phase 122 may include a single crystalline zone. FIGS. 1A and 1B illustrate an example having one single crystalline zone 122. And, as in the modified example of FIG. 2, the Fe-based phase 122 may include two or more single crystalline zones (e.g., 122a and 122b). In this manner, the Fe-based phase 122 may a polycrystalline structure in which the single crystalline zone (e.g., 122a and 122b) is provided in plural. In this case, the single crystalline zones 122a and 122b do not need to be adjacent to each other, and may exist spaced apart from each other in the magnetic metal particle 101.

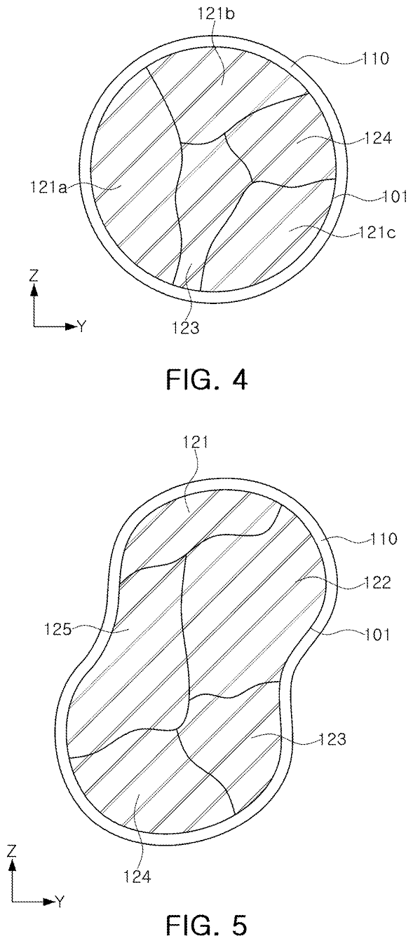

Referring to FIG. 1B, the plurality of phases 121 to 125 may include an amorphous phase 121, and FIGS. 1A, 1B, and 2 show an example in which the amorphous phase 121 is one. The number of amorphous phases 121 may be two or more. In addition, in the present embodiment, the magnetic metal particle 101 may include an amorphous phase 121 and a single crystalline zone 122, but only one thereof may be present. Specifically, as in the modified example of FIG. 3, the magnetic metal particle 101 may include Fe-based single crystalline zones 122a, 122b, and 122c, and may not include an amorphous phase. Conversely, as in the modified example of FIG. 4, the magnetic metal particle 101 may include amorphous phases 121a, 121b, and 121c, and may not include a single crystalline zone.

Referring to FIG. 1B, the single crystalline zone 122 may include at least one selected from the group consisting of an Fe(001) phase, an Fe(011) phase, an Fe(002) phase, an Fe(101) phase, an Fe(111) phase, and an Fe(224) phase. The single crystalline zone 122 may be defined as a zone in which a crystal present therein has a certain orientation. As in the modified examples of FIGS. 2 and 3, when a plurality of single crystalline zones 122a, 122b, and 122c exist, they may have different orientations. In addition, the amorphous phase 121 may include at least one of an Fe-based metal or an Fe-based metal oxide, wherein the Fe-based metal may include at least one selected from the group consisting of iron (Fe), silicon (Si), chromium (Cr), cobalt (Co), molybdenum (Mo), aluminum (Al), niobium (Nb), copper (Cu), and nickel (Ni). Specifically, the Fe-based metal may include at least one of an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, or an Fe—Cr—Al-based alloy. For example, when the Fe-based alloy includes an Fe—Cr—Sr—based alloy, wt % of Si and Cr may be 15% or less, and as a more specific example, 0.80 wt %<Si<12.5 wt %, and 2.5 wt % %<Cr<14.2 wt %. In this case, the Fe-based metal oxide may be an oxide of the above-described Fe-based metal.

As described above, the magnetic metal particle 101 may include Fe₃O₄ phases 123 to 125, and FIGS. 1A, 1B, and 2 illustrate an example in which three Fe₃O₄ phases 123 to 125 exist. As illustrated in FIGS. 3 and 4, the number of Fe₃O₄ phases 123 and 124 may be two, or may be less than one or four or more. The Fe₃O₄ phases 123 to 125 may include single crystalline zones, and FIGS. 1A and 1B illustrate an example in which three single crystalline zones 123 to 125 exist. In this case, the single crystalline zones 123 to 125 may include at least one selected from the group consisting of an Fe₃O₄ (022) phase, an Fe₃O₄ (113) phase, an Fe₃O₄ (311) phase, and an Fe₃O₄ (111) phase. As in the present embodiment, when a plurality of single crystalline zones 123 to 125 of the Fe₃O₄ phase exist, they may have different orientations.

Existence or amount ratios (e.g., areas) of the plurality of phases 121 to 125 present in the magnetic metal particle 101 may be determined through cross-section analysis (e.g., HR-TEM analysis), XRD analysis, chemical analysis, or the like of the magnetic metal particle 101. As an example, the plurality of phases 121 to 125 may be identified through HR-TEM (e.g., JEOL's 2100F) crystal pattern analysis, and area ratios may also be obtained therefrom. Through the obtained area ratios, an amount ratio (e.g., area ratio) of each of the plurality of phases 121 to 125 may be obtained, and areas of the plurality of phases 121 to 125 may be occupied areas, for example, in a Z-Y plane passing through a center of the magnetic metal particle 101. In a material forming a plurality of phases 121 to 125, it may be known through STEM-EDS analysis. Existence of Fe and Fe₃O₄ may also be known through XRD analysis, and crystallinity and an oxide type may be confirmed in each region by XRD analysis. Specifically, when the Fe₃O₄ phases 123 to 125 are included, a single Fe peak as well as a magnetite Fe₃O₄ peak may be detected. In addition, crystal structures of the Fe₃O₄ phases 123 to 125 may be known through HR-TEM analysis, and crystal structures of the Fe₃O₄ phases were confirmed in the magnetic particles 100 obtained, as a result of TEM image simulation performed by the present inventors, and it was confirmed that there was no result matching γ-Fe₂O₃.

In the present embodiment, in the magnetic metal particle 101, a plurality of phases 121 to 125 may exist, and in particular, an amorphous phase 121, an Fe-based phase 122, and Fe₃O₄ phases 123 to 125 may be included. In the magnetic particle 100 including the magnetic metal particle 101, it is preferable to have high amorphousness, e.g., a large amount (e.g., area) of the amorphous phase 121 to lower coercive force, but there may be a limit to increasing amorphousness in a manufacturing process of the magnetic particle 100. And as a size of the magnetic particle 100 decreases, it may be more difficult to secure amorphousness. When a size of the magnetic particles 100 is reduced, a specific surface area may increase and natural oxidation may be likely to occur. In this case, magnetic properties of the magnetic particle 100 may be deteriorated due to generation of a non-magnetic Fe₂O₃ phase. As described above, the Fe-based phase 122 of the magnetic metal particle 101 does not necessarily have to include a single crystalline zone, and as amorphousness is very high, the Fe-based phase 122 may not substantially include a single crystalline or polycrystalline structure. In this manner, when the magnetic metal particle 101 does not substantially include a single crystalline zone other than the amorphous phase 121 and the Fe₃O₄ phases 123 to 125, an amount (e.g., an area) of the amorphous phase 121 does not necessarily need to be more than amounts (e.g., areas) of the Fe₃O₄ phase 123 to 125, and amounts (e.g., areas) thereof may be adjusted, as necessary.

In the present embodiment, the magnetic metal particle 101 may include the Fe₃O₄ phases 123 to 125, which may be a magnetic oxide, in addition to the amorphous phase 121 and the Fe-based phase 122, to minimize degradation of characteristics of the magnetic particle 100. In addition, coercive force or the like of the magnetic particle 100 may be effectively controlled by optimizing relative amounts (e.g., areas) of the amorphous phase 121, the Fe-based phase 122, and the Fe₃O₄ phases 123 to 125. Specifically, amount ratios (e.g., area ratios) occupied by the Fe₃O₄ phases 123 to 125 in the magnetic metal particle 101 may be less than 50%. This may be a condition considering that amounts (e.g., areas) of the Fe₃O₄ phases 123 to 125 are too large, such that Ms characteristics or the like of the magnetic particles 100 are deteriorated, when the amounts (e.g., areas) are equal to or larger than amounts (e.g., areas) of remaining phases 121 and 122. As a specific condition, in relative amounts (e.g., areas) of the amorphous phase 121, the Fe-based phase 122, and the Fe₃O₄ phases 123 to 125, area ratios of the Fe₃O₄ phases 123 and 124 in the magnetic metal particle 101 may be 15% to less than 50%, more specifically 19% or more and 42.3% or less. In this case, relative amounts (e.g., areas) of the amorphous phase 121, the Fe-based phase 122, and the Fe₃O₄ phases 123 to 125 may be obtained through an area ratio of a cross-section of the magnetic metal particle 101. When amount ratios (e.g., area ratios) of the Fe₃O₄ phases 123 and 124 are as low as 19% or less, or 15% or less, the magnetic metal particle 101 may have a structure in which an amorphous phase 121 and an Fe-based phase 122 are mixed. In this case, there may be a limit to securing enough magnetic permeability, and there may be a limit to increasing a packing density in the magnetic component in terms of shape. The following may be results of analyzing magnetic properties and a packing density according to amounts (e.g., areas) of the Fe₃O₄ phases 123 and 124. According thereto, sufficient characteristics may be obtained at a level of which amount ratios (e.g., area ratios) of the Fe₃O₄ phases 123 and 124 in the magnetic metal particle 101 are less than 50%. In addition, it was confirmed that when amount ratios (e.g., area ratios) of the Fe₃O₄ phases 123 and 124 in the magnetic metal particle 101 are 19% or more and 42.3% or less, it is more preferable in terms of characteristics such as magnetic permeability, a packing density, or the like.

TABLE 1

| Fe₃O₄ | | | | | | Packing |
|---|---|---|---|---|---|---|
| Phase | Ms | | Magnetic | | | Density |
| Ratio (%) | (emu/g) | Hc (Oe) | Permeability | Q | Rs (mΩ) | (%) |
| 81 | 96.798 | 143.81 | 35.8 | 42 | 562.58 | 83.47 |
| 51 | 158.62 | 71.484 | 37.8 | 45.7 | 541.76 | 83.99 |
| 42.3 | 170 | 136 | 39.8 | 46.1 | 578.22 | 84.88 |
| 35 | 178.49 | 112.27 | 41.1 | 41.9 | 633.68 | 85.19 |
| 34 | 177.25 | 80.502 | 40 | 47.7 | 557.22 | 85.46 |
| 19.6 | 180.37 | 99.215 | 42.3 | 41 | 661.41 | 85.79 |
| 15.1 | 164.73 | 87.89 | 36.3 | 45.9 | 545.48 | 82.21 |

Positions in which the Fe₃O₄ phases 123 to 125 exist in the magnetic particle 100 may also affect characteristics of the magnetic particle 100. Unlike the present embodiment, when the Fe₃O₄ phases 123 to 125 are mainly present on a surface of the magnetic metal particle 100, to be similar to a case of coating the magnetic metal particle 100, there may be similar limitations to a case having lower amounts (e.g., areas) of the Fe₃O₄ phases 123 to 125. Therefore, it is preferable that ratios of the Fe₃O₄ phases 123 to 125 present on the surface of the magnetic metal particle 101 are less than 70%. In this case, the ratios of the Fe₃O₄ phases 123 to 125 may be measured, for example, in the Z-Y plane passing through a center of the magnetic metal particle 101. Specifically, it may be obtained by extracting outer lines of the magnetic metal particle 101 from the Z-Y plane and calculating the ratios of lines corresponding to the Fe₃O₄ phases 123 to 125 thereamong. In a condition of less than 70%, it may not be necessarily applied together with the above-mentioned content condition, e.g., amount ratios (e.g., area ratios) of the Fe₃O₄ phases 123 to 125 may be less than 50%, and the magnetic particles 100 may only satisfy the condition of less than 70%. In addition, as illustrated in FIG. 4, at least a portion of the Fe₃O₄ phases 123 to 125 may be present in a central portion of a cross-section passing through a center of the magnetic metal particle 101, for example, of the Z-Y plane.

The oxide film 110 may be formed on a surface of the magnetic metal particle 101, to protect the magnetic metal particle 101 and to have the magnetic particle 101 electrically insulated from the outside. Loss of eddy current of the magnetic particles 100 may be reduced by the oxide film 110. Since the oxide film 110 may include a crystalline zone, and the crystalline zone may include an Fe₃O₄ component, deterioration in characteristics of the magnetic particle 100 may be minimized. In this case, an Fe₃O₄ component of the crystalline zone may have an orientation structure different from that of the Fe₃O₄ phases 123 to 125 of the magnetic metal particle 101. A thickness T of the oxide film 110 may be 5 to 20 nm.

A size of the magnetic particle 100 may correspond to a diameter D, which may be an ultra-differential size, in a range of 10 to 900 nm. The diameter D of the magnetic particle 100 may be measured in a cross-section of a central portion. For example, an image may be obtained by capturing a Z-Y plane passing through the center of the magnetic particle 100 with a scanning electron microscope (SEM). In this case, an image pixel size in an SEM image may be 10 nm, and a working distance may be fixed at 8 mm. And, as a mode thereof, a back scattered mode may be used. Thereafter, a diameter D may be calculated using an image analysis program (e.g., ORS's deep learning tool). The magnetic particle 100 may have a spherical or substantially spherical shape, but the present disclosure is not limited thereto. For example, as in the modified example of FIG. 5, the magnetic particle 100 may have an aspherical shape. Such a shape may be obtained as sphericity of the magnetic metal particle 101 is lowered during an oxidation process. When the magnetic particle 100 has an arbitrary shape that does not maintain a spherical shape, the above-mentioned diameter may be interpreted as being replaced with a Feret diameter, and an average value of the diameter may be also replaced with an average value of the Feret diameter. As a method of calculating the average value of the diameter, a tool of the image processing software may be used. This may be an example of a method of individually analyzing the size of the magnetic particle 100, and as will be described later, a size of a magnetic particle 100 included in magnetic components 200, 400, and 500 may be measured through cross-sectional images of the magnetic components 200, 400, and 500, when analyzing the same. The thickness of the oxide film 110 may be measured similarly.

In an example of a manufacturing method for the magnetic metal particle 101 to include the above-described complex structure, e.g., the amorphous phase 121, the Fe-based phase 122, and the Fe₃O₄ phases 123 to 125, a raw material may be evaporated using an RF plasma process, and then cooled using an inert gas, to form a fine powder. In this process, a polycrystal or a polycrystalline structure may be obtained, depending on an oxidizing atmosphere and gas, and a composition of the magnetic metal particle 101. By adjusting these process variables, the magnetic particle 100 having the above-described structure may be obtained. In this case, a process of separating a powder having a large particle size may be performed by moving an obtained powder through an airflow, or the like.

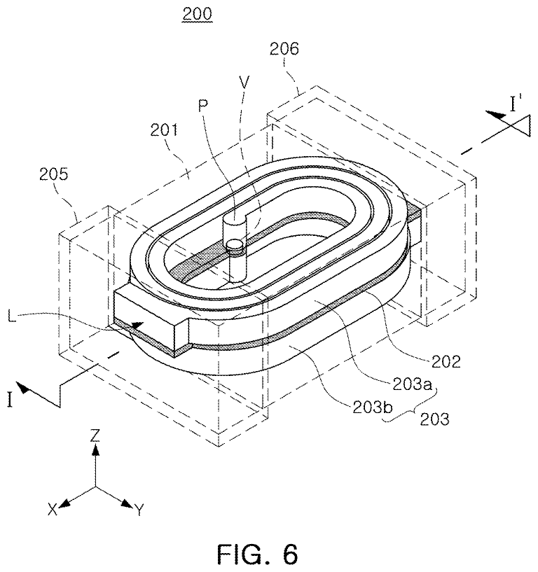

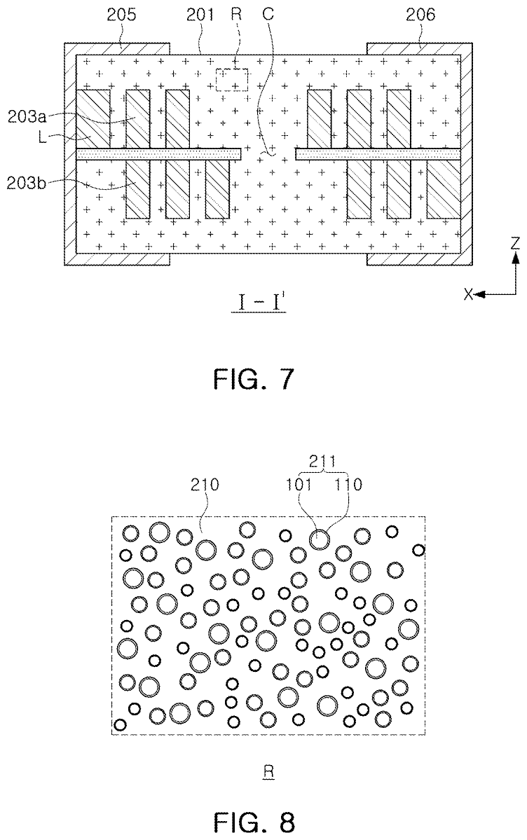

Hereinafter, an example of a magnetic component including the above-described magnetic particle will be described. Referring to FIGS. 6 to 8, in the present embodiment, a magnetic component 200 including a plurality of magnetic particles 211 corresponds to a coil component. Specifically, the magnetic component 200 may include a body 201, a support member 202, a coil pattern 203, and external electrodes 205 and 206, and the body 201 may include a plurality of magnetic particles 211. In this case, at least one magnetic particle, among the plurality of magnetic particles 211, may include the above-described composite structure, e.g., a magnetic metal particle 101 having a plurality of phases 121 to 125. In this case, an Fe-based phase 122 and Fe₃O₄ phases 123 to 125 may be included, and in this case, amount ratios (e.g., area ratios) of the Fe₃O₄ phase 123 to 125 among the plurality of phases 121 to 125 may be less than 50%. And the plurality of phases 121 to 125 may include an amorphous phase 121.

The body 201 may seal at least a portion of the support member 202 and at least a portion of the coil 203, to form an exterior of the magnetic component 200. Also, the body 201 may be formed such that a partial region of a lead-out pattern L is exposed externally. As illustrated in FIG. 8, the body 201 may include a plurality of magnetic particles 211, and the magnetic particles 211 may be dispersed in an insulating material 210. The insulating material 210 may include a polymer component such as an epoxy resin, polyimide, or the like. The body 201 may include a plurality of magnetic particles 211, and at least one magnetic particle, among the plurality of magnetic particles 211, may have a composite structure, as described with reference to FIGS. 1A to 5. As described above, coercive force of a magnetic particle 211 in which a magnetic metal particle 101 has a composite structure, may be reduced, and in a magnetic component 200 using the same, a Q characteristic and a loss characteristic may be improved. When a magnetic particle 211 having the above-described magnetic metal particle 101, e.g., a magnetic metal particle 101 including an Fe-based phase 122 and Fe₃O₄ phases 123 to 125, among the magnetic particles 211, is referred to as a composite particle 211, the composite particle 211 may be included as a plurality of composite particles 211 in the body 201, and the plurality of composite particles 211 may have D50 of a diameter of 100 to 300 nm, respectively. In this case, D50 means a value located in a center when arranged in the order of diameter size.

A diameter of the magnetic particle 211 present in the body 201 may be measured in a cross-section of the body 201. Specifically, with respect to a cross-section in X-Z directions passing through a center of the body 201, a plurality of regions (e.g., five (5) or ten (10) regions) at equal intervals in a Y-direction may be photographed with a scanning electron microscope, and then the diameter of the magnetic particle 211 may be obtained using an image analysis program. In this case, since the magnetic particle 211 may be deformed or the oxide film 110 may be destroyed in an outer region of the body 201 by a compression process or the like, the diameter of the magnetic particle 211 may be measured except for this. For example, a region corresponding to a length within 5% or 10% from a surface of the body 201 may be excluded.

In relation to an example of a manufacturing method, the body 201 may be formed by a lamination method. Specifically, after forming the coil 203 on the support member 202 using a method such as plating or the like, a unit stack for manufacturing the body 201 may be prepared as a plurality of unit stacks, and a plurality of unit stacks may be stacked. In this case, the unit stack may be prepared by mixing the magnetic particle 211 such as a metal or the like, and an organic material such as a thermosetting resin, a binder, a solvent, or the like, to prepare a slurry, and applying and drying the slurry to a carrier film by a doctor blade method by a thickness of several tens of μm, to have a sheet type. Therefore, the unit stack may be prepared in a manner in which magnetic particles are dispersed in a thermosetting resin such as an epoxy resin, polyimide, or the like. The body 201 may be implemented by forming a plurality of the above-described unit stacks, and pressing and stacking them in upward and downward directions based on the coil 203.

The support member 202 may support the coil 203, and may be formed of a polypropylene glycol (PPG) substrate, a ferrite substrate, a metal-based soft magnetic substrate, or the like. As illustrated, a central portion of the support member 202 may be penetrated to form a through-hole, and a portion of the body 201 may be filled in the through-hole to form a magnetic core portion C.

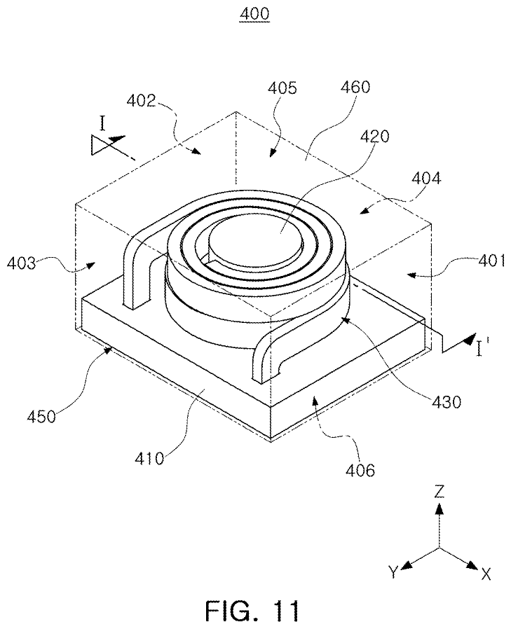

The coil 203 may be mounted into the body 201, and may serve to perform various functions in an electronic device due to characteristics expressed from the coil of the magnetic component 200. For example, the magnetic component 200 may be a power inductor, and in this case, the coil 203 may play a role for storing electricity as a magnetic field to maintain an output voltage, to stabilize power, or the like. In this case, a coil pattern constituting the coil 203 may include a first coil 203a and a second coil 203b, as stacked on both surfaces of the support member 202, respectively, and the first coil 203a and the second coil 203b may be electrically connected to each other through a conductive via V passing through the support member 202. In this case, the coil 203 may include a pad region P. The coil 203 may be formed to have a spiral shape. In an outermost portion of the spiral shape, a lead-out portion T exposed to the outside of the body 201 for electrical connection with the external electrodes 205 and 206 may be included. Unlike those illustrated, the coil 203 may be disposed on only one surface of the support member 202. The coil pattern constituting the coil 203 may be formed using a plating process used in the art, such as pattern plating, anisotropic plating, isotropic plating, or the like, a plurality of processes among these processes may be used to have a multilayer structure. The coil 203 may be implemented as a winding type coil structure, and in this case, the support member 202 may not be included in the body 201. The winding-type coil structure will be described in detail in embodiments below with reference to FIG. 11.

The external electrodes 205 and 206 may be formed outside the body 201, to be connected to the lead-out portion T. The external electrodes 205 and 206 may be formed using a paste containing a metal having excellent electrical conductivity, and the paste may be, for example, a conductive paste containing nickel (Ni), copper (Cu), tin (Sn), silver (Ag), or the like, alone, or alloys thereof. In addition, a plating layer may be further formed on the external electrodes 205 and 206. In this case, the plating layer may include any one or more selected from the group consisting of nickel (Ni), copper (Cu), and tin (Sn), and, for example, a nickel (Ni) layer and a tin (Sn) layer may be formed sequentially.

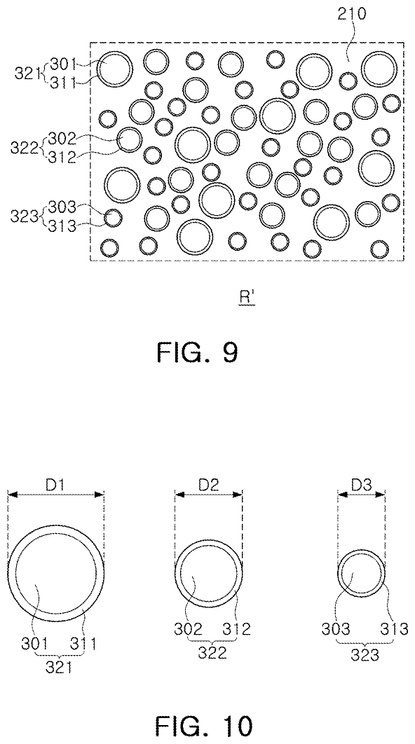

A magnetic component according to another embodiment will be described with reference to FIGS. 9 and 10. An embodiment of FIGS. 9 and 10 may be different from the embodiment of FIGS. 6 to 8 in view that a magnetic particle is present in a body. Since other components may be equally employed, a redundant description will be omitted. In the present embodiment, the body 201 may include a plurality of magnetic particles 321, 322, and 323, and the plurality of magnetic particles 321, 322, and 323 may include first to third magnetic particles 321, 322, and 323 respectively including first to third magnetic metal particles 301, 302 and 303. In this case, the plurality of magnetic particles 321, 322, and 323 may have different sized diameters. Specifically, the first magnetic particle 321 may have a diameter D1 in a first diameter range, the second magnetic particle 322 may have a diameter D2 in a second diameter range, smaller than the first diameter range, and the third magnetic particle 323 may have a diameter D3 in a third diameter range, smaller than the second diameter range. As a specific example, the first diameter range may be 5 to 61 μm, and the second diameter range may be 0.6 to 4.5 μm. Also, the third diameter range may be 10 to 900 nm. The diameters of the first to third magnetic particles 321, 322, and 323 may be diameters measured in a cross-section of the body 201 using the methods and/or tools disclosed herein. Other methods and/or tools appreciated by one of ordinary skill in the art, even if not described in the present disclosure, may also be used. In the present embodiment, the third magnetic particle 323 having the smallest size may have a single crystalline structure, e.g., a structure including a single crystalline zone containing an Fe component, such that coercive force is reduced, and thus a Q characteristic and a loss characteristic may be improved. The second magnetic particle 322 and the third magnetic particle 323 may partially overlap in diameter ranges. In this case, the second and third magnetic metal particles 302 and 303 may include different materials. Therefore, the second magnetic particle 322 and the third magnetic particle 323 may be distinguished by using a method such as SEM-EDS, XRF, or the like. In addition, to more clearly distinguish the first and third magnetic particles 321, 322, and 323, the first to third diameter ranges may not overlap each other, and, for example, the first diameter range may be 5 to 61 μm, the second diameter range may be 0.9 to 4.5 μm, and the third diameter range may be 10 to 800 nm.

As in the present embodiment, a plurality of types of magnetic particles 321, 322, and 323, having different sizes from each other, may be used to improve packing densities of the magnetic particles 321, 322, and 323 in the body 201, and from this, a magnetic characteristic of the magnetic component 200 may be improved. In addition, in an ultrafine powder having a relatively small size, it may be difficult to have an amorphous form, and, thus, it may be difficult to sufficiently lower coercive force. As in the present embodiment, coercive force may be remarkably reduced by implementing a small size of the third magnetic metal particles 303 as the composite particles described above.

The first to third magnetic metal particles 301, 302, and 303 may be at least one of pure iron, an Fe—Si-based alloy, an Fe—Si—Al-based alloy, an Fe—Ni-based alloy, an Fe—Ni—Mo-based alloy, an Fe—Ni—Mo—Cu-based alloy, an Fe—Co-based alloy, an Fe—Ni—Co-based alloy, an Fe—Cr-based alloy, an Fe—Cr—Si-based alloy, an Fe—Si—Cu—Nb-based alloy, an Fe—Ni—Cr-based alloy, and an Fe—Cr—Al-based alloy. The first magnetic particle 321 may include a first oxide film 311 formed on a surface of the first magnetic metal particle 301. Similarly, the second magnetic particle 322 may include a second oxide film 312 formed on a surface of the second magnetic metal particle 302, and the third magnetic particle 323 may include a third oxide film 313 formed on a surface of the third magnetic metal particle 303. The first to third oxide films 311, 312, and 313 may include an Fe oxide, for example, Fe₂O₃, Fe₃O₄, or the like. In addition, the first to third oxide films 311, 312, and 313 may include phosphate, ferrite (e.g., NiZnCu ferrite, NiZn ferrite), or the like. In addition, an oxide such as MgO, Al₂O₃, or the like may be included.

The inventors of the present disclosure have experimented with a change in characteristics (magnetic permeability, core loss, or the like) according to relative amounts (e.g., areas) of the first to third magnetic particles 321, 322, and 323, present in the body 201, and results therefrom are illustrated in Tables 2 to 4. As described above, diameters of the magnetic particles 321, 322, and 323, present in the body 201, may be measured in a cross-section of the body 201. Specifically, with respect to a cross-section in the X-Z directions passing through a center of the body 201, a plurality of regions (e.g., five (5) or ten (10) regions) at equal intervals in the Y-direction may be imaged with a scanning electron microscope, and then diameters of the magnetic particles 321, 322, and 323 may be obtained using an image analysis program. In addition, as a specific example, in an SEM image, an image pixel size may be fixed to be 10 nm by 10 nm and a working distance may be fixed to be 8 mm. In addition, a back scattered mode may be used. Thereafter, an average value of diameters may be calculated using an image analysis program (e.g., ORS's deep learning tool). The magnetic particles 321, 322 and 323 may have a spherical shape or a substantially spherical shape, but the present disclosure is not limited thereto. For example, the magnetic particles 321, 322, and 323 may have an aspherical shape. Such a shape may be obtained as sphericity of the magnetic particles 321, 322, and 323 is lowered during an oxidation process. When the magnetic particles 321, 322 and 323 have an arbitrary shape that does not maintain a spherical shape, the above-mentioned diameter may be interpreted as being replaced with a Feret diameter, and an average value of the diameter may be interpreted as being also replaced with an average value of the Feret diameter. As a method of calculating the average value of the diameter, a tool of the image processing software may be used, and size distribution may be obtained by particle size analysis for each region. The magnetic particles 321, 322, and 323 may be deformed or the oxide film 110 may be destroyed in an outer region of the body 201 by a compression process, or the like, the magnetic particles 321, 322, and 323 may be excluded in the measurement, and, for example, a region corresponding to a length within 5% or 10% from a surface of the body 201 may be excluded. In addition, as another example, it is possible to infer a size of the destroyed particle through a size measured at three (3) points where destruction does not occur. Moreover, despite the aforementioned explanations, only one cross-section (i.e., a X-Y plane including the center of the magnetic component) may be used to obtain sizes of the magnetic particles 321, 322 and 323.

Using the above-mentioned method or the like, a magnetic particle may be classified as the first magnetic particle when a diameter range thereof is 5 to 61 μm, as the second magnetic particle when a diameter range thereof is 0.6 to 4.5 μm, or as the third magnetic particle when a diameter range thereof is 10 to 900 nm. And, an amount ratio (e.g., area ratio) of each of the first to third magnetic particles, relative to a sum of amounts (e.g., areas) of the first to third magnetic particles for each sample, was expressed as a percentage, and magnetic permeability and core loss were measured.

First, Table 2 below illustrates results for samples having a D50 of the first magnetic particle of 21 to 36 μm, and samples 1, 2, and 9 marked with * correspond to comparative examples. In magnetic permeability, a case in which it increased by 5% or more increases, as compared to a reference sample, was indicated by “O,” and a case in which it did not increase by 5% was indicated by “X.” In this case, in the reference sample, a ratio of amounts (e.g., a ratio of areas) of the first and second magnetic particles was 76:24, and the third magnetic particle was not included. Moreover, in core loss/Q, it was marked as bad (X) when Q decreased by 30% or more in the magnetic permeability increased, as compared to the reference sample (e.g., as bad when Q decreased by 6.5 or more when the magnetic permeability increased by 5). In this case, the amount ratios (e.g., area ratios) may correspond to area ratios obtained from cross-section images acquired using the above-mentioned measurement method.

TABLE 2

| | Area Ratio (%) | | | | |
|---|---|---|---|---|---|
| | First Magnetic | Second Magnetic | Third Magnetic | Magnetic | Core |
| Sample | Particle | Particle | Particle | Permeability | Loss/Q |
| 1* | 100 | 0 | 0 | x | x |
| 2* | 76 | 4 | 20 | x | x |
| 3 | 76 | 9 | 15 | ○ | ○ |
| 4 | 76 | 10.6 | 13.4 | ○ | ○ |
| 5 | 76 | 12 | 12 | ○ | ○ |
| 6 | 76 | 13.5 | 10.5 | ○ | ○ |
| 7 | 76 | 15 | 9 | ○ | ○ |
| 8 | 76 | 16.4 | 7.6 | ○ | ○ |
| 9* | 76 | 20 | 4 | x | ○ |

Table 3 below illustrates results for samples having D50 of the first magnetic particle of 12 to 21 μm, and samples 10, 17, and 18 marked with * correspond to comparative examples.

TABLE 3

| | Area Ratio (%) | | | | |
|---|---|---|---|---|---|
| | First Magnetic | Second Magnetic | Third Magnetic | Magnetic | Core |
| Sample | Particle | Particle | Particle | Permeability | Loss/Q |
| 10* | 76 | 6.5 | 17.5 | x | x |
| 11 | 76 | 9 | 15 | ○ | ○ |
| 12 | 76 | 11 | 13 | ○ | ○ |
| 13 | 76 | 12 | 12 | ○ | ○ |
| 14 | 76 | 13 | 11 | ○ | ○ |
| 15 | 76 | 14.8 | 9.2 | ○ | ○ |
| 16 | 76 | 16.2 | 7.8 | ○ | ○ |
| 17* | 76 | 17 | 7 | x | x |
| 18* | 72 | 10 | 18 | x | x |
| 19 | 72 | 12 | 16 | ○ | ○ |
| 20 | 72 | 14 | 14 | ○ | ○ |

Table 4 below illustrates results for samples having D50 of the first magnetic particle of 5 to 12 μm, and samples 21 and 31 marked with * correspond to comparative examples.

TABLE 4

| | Area Ratio (%) | | | | |
|---|---|---|---|---|---|
| | First Magnetic | Second Magnetic | Third Magnetic | Magnetic | Core |
| Sample | Particle | Particle | Particle | Permeability | Loss/Q |
| 21* | 64 | 18 | 18 | ○ | x |
| 22 | 64 | 20 | 16 | ○ | ○ |
| 23 | 64 | 22 | 14 | ○ | ○ |
| 24 | 64 | 24 | 12 | ○ | ○ |
| 25 | 64 | 26 | 10 | ○ | ○ |
| 26 | 68 | 16 | 16 | ○ | ○ |
| 27 | 72 | 14 | 14 | ○ | ○ |
| 28 | 72 | 16 | 12 | ○ | ○ |
| 29 | 76 | 12 | 12 | ○ | ○ |
| 30 | 76 | 16 | 8 | ○ | ○ |
| 31* | 76 | 20 | 4 | x | ○ |

An optimized ratio of the first to third magnetic particles may be derived according to the above experimental results. Specifically, an amount ratio (e.g., area ratio) of the first magnetic particle may be 90% or less, and an amount ratio (e.g., area ratio) of the third magnetic particle may be 7.6 to 16%. In this case, it may be confirmed that good performance is illustrated in terms of magnetic permeability and core loss characteristics. In this case, when a ratio of the first magnetic particle having a relatively large size is lowered to less than half, a problem in which an overall packing density of the magnetic particle is lowered to increase magnetic permeability loss may occur. Therefore, the amount ratio (e.g., area ratio) of the first magnetic particle is preferably 50% or more.

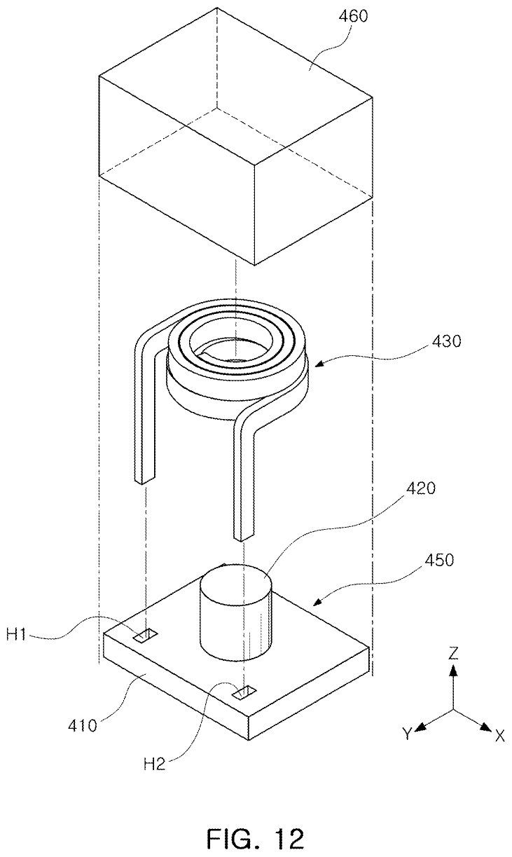

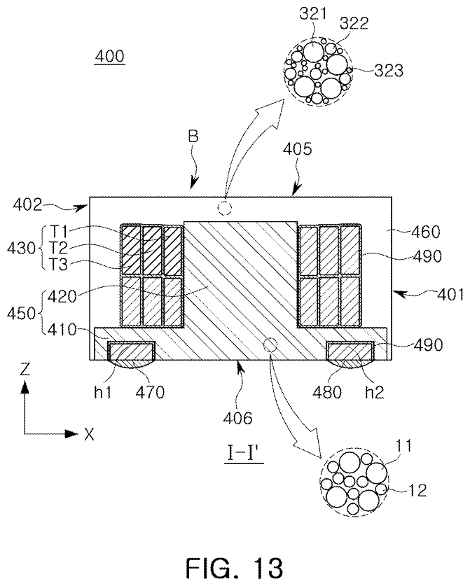

Hereinafter, a magnetic component having a wound coil structure as another type of magnetic component including the above-described magnetic particle will be described. First, referring to FIGS. 11 to 13, a magnetic component 400 may include a mold portion 450, a coil portion 430, a cover portion 460, and accommodating grooves h1 and h2, and may further include external electrode 470 and 480. A body B may form an exterior of the magnetic component 400, and the coil portion 430 may be embedded therein. The body B may include the mold portion 450 and the cover portion 460. The mold portion 450 may include a core 420. The body B may be formed to have a hexahedral shape as a whole. The body B may include a first surface 401 and a second surface 402, opposing each other in a first direction X, a third surface 403 and a fourth surface 404, opposing each other in a second direction Y, a fifth surface 405 and a sixth surface 406, opposing in a third direction Z. Each of the first to fourth surfaces 401, 402, 403, and 404 of the body B may correspond to a wall surface of the body B, connecting the fifth surface 405 and the sixth surface 406 of the body B. Hereinafter, both end surfaces of the body B mean the first surface 401 and the second surface 402 of the body B, and both side surfaces of the body B mean the third surface 403 and the fourth surface 404 of the body B.

A body B may be formed, but is illustrative, such that a magnetic component 400 according to the present embodiment in which external electrodes 470 and 480 to be described later are formed has a length of 2.0 mm, a width of 1.2 mm, and a thickness of 0.6 mm, but the present disclosure is not limited thereto. The body B may include a mold portion 450 and a cover portion 460. The cover portion 460 may be disposed on the mold portion 450, to surround all surfaces of the mold portion 450 except for a lower surface thereof. Therefore, the first to fifth surfaces 401, 402, 403, 404, and 405 of the body B may be formed by the cover portion 460, and the sixth surface 406 of the body B may be formed by the mold portion 450 and the cover portion 460. The mold portion 450 may have one surface and the other surface, opposing each other. The one surface of the mold portion 450 may be a surface corresponding to the lower surface of the mold portion 450, and refers to a region in which accommodating grooves h1 and h2 to be described later are disposed. As will be described later, since the accommodating grooves h1 and h2 are processed in the mold portion 450, lower surfaces of the accommodating grooves h1 and h2 may be disposed in a region between the one surface and the other surface of the mold portion 450. The mold portion 450 may include a support portion 410 and a core 420. The core 420 may pass through the coil portion 430, to be disposed in a central portion of the other surface of the support portion 410. For the above reasons, in the present specification, the one surface and the other surface of the mold portion 450 may be used in the same meaning as one surface and the other surface of the support portion 410, respectively. The mold portion 450 may be formed by filling a mold with a composite material including the magnetic particles 321, 322, and 323 of FIG. 10 and an insulating resin. In this case, the insulating resin may include, but is not limited to, epoxy, polyimide, a liquid crystal polymer, or the like, alone or in combination.

The coil portion 430 may be embedded in the body B, to express characteristics of the magnetic component 400. For example, when the magnetic component 400 of the present embodiment is used as a power inductor, the coil portion 430 may play a role for storing an electric field as a magnetic field to maintain an output voltage, to stabilize power of an electronic device. The coil portion 430 may be disposed on the other surface of the mold portion 450. Specifically, the coil portion 430 may be wound around the core 420, and may be disposed on the other surface of the support portion 410. The coil portion 430 may be an air-core coil, and may be configured as a flat coil. The coil portion 430 may be formed by winding a metal wire such as a copper wire or the like of which surface is coated with an insulating material in a spiral shape. The coil portion 430 may be comprised of a plurality of layers. Each of the layers of the coil portion 430 may be formed to have a planar spiral shape, and may have a plurality of turns. For example, the coil portion 430 may form an innermost turn T1, at least one intermediate turn T2, and an outermost turn T3, from a central portion of one surface of the mold portion 450 in an outward direction.

The cover portion 460 may be disposed on the mold portion 450 and the coil portion 430. The cover portion 460 may cover the mold portion 450 and the coil portion 430. The cover portion 460 may be disposed on the support portion 410 and the core 420 of the mold portion 450, and the coil portion 430, and then pressurized to be coupled to the mold portion 450. At least one of the mold portion 450 or the cover portion 460 may include the magnetic metal particles 321, 322, and 323 of FIG. 10, and in the present embodiment, each of the mold portion 450 and the cover portion 460 may include the magnetic metal particles 321, 322, and 323 of FIG. 10.

First and second accommodating grooves h1 and h2 may be formed on one surface of the mold portion 450 to be spaced apart from each other, and the first and second accommodating grooves h1 and h2 may have both end portions of the coil portion 430 to be described later. For example, the first and second accommodating grooves h1 and h2 may be respectively formed on the one surface of the mold portion 450, and may be spaced apart from each other in a longitudinal direction X. The first and second accommodating grooves h1 and h2 may be disposed outside a region corresponding to the core 420, on the one surface of the mold portion 450, but the present disclosure is not limited thereto. Each of the first and second accommodating grooves h1 and h2 may be formed to extend in one direction from the one surface of the mold portion 450, but may be formed in a non-limited form, when having a structure that may effectively expose both end portions of the coil portion 430.

Since the body B may be a region including the mold portion 450 and the cover portion 460, one surface of the body B means one surface of the region including the mold portion 450 and the cover portion 460. The coil portion 430 may be drawn out externally, and may include first and second lead-out portions disposed in the first and second accommodating grooves h1 and h2, respectively. The first and second accommodating grooves h1 and h2 may be regions in which both end portions of the coil portion 430 are drawn out to the external electrodes 470 and 480, and may thus formed on one surface of the body B to be spaced apart from each other to correspond to the first and second external electrodes 470 and 480, respectively.

As an example, through-grooves H1 and H2 may be formed by a mold in forming the mold portion 450, and first and second accommodating grooves h1 and h2 may be formed on the mold portion 450 in a process of forming the cover portion 460 by laminating and pressing a magnetic sheet including a magnetic metal particle. In the mold for forming the mold portion 450, protrusions corresponding to the through-grooves H1 and H2 may be formed, and the through-grooves H1 and H2 may be formed in the mold portion 450 manufactured to have a shape corresponding to a shape of the mold. Also, the first and second accommodating grooves h1 and h2 may not be formed in a process of forming the mold portion 450, but may be formed in a process of forming the cover portion 460 on the mold portion 450. For example, both end portions of the coil portion 300 protruding from the one surface of the mold portion 450 through the through-grooves H1 and H2 of the mold portion 450 may be embedded in the mold portion 450 in a process of pressing the magnetic sheet. Therefore, the first and second accommodating grooves h1 and h2 may be formed on the one surface of the mold portion 450. Alternatively, the first and second accommodating grooves h1 and h2 and the through-grooves H1 and H2 may be formed in the process of forming the mold portion 450 using a mold. In this case, protrusions corresponding to the first and second accommodating grooves h1 and h2 and the through-grooves H1 and H2 may be formed in the mold used to form the mold portion 450.

Both end portions of the coil portion 430 may pass through the one surface of the mold portion 450, to be disposed in the first and second accommodating grooves h1 and h2, respectively. Since a shape in which an end portion of the coil portion 430 is disposed in the accommodating grooves h1 and h2 may not be limited, widths of the first and second accommodating grooves h1 and h2 may be equal to or different from widths of the through-grooves H1 and H2. Both end portions of the coil portion 430 may be exposed from the one surface of the mold portion 450, e.g., the sixth surface 406 of the body B. Both end portions of the coil portion 430 exposed from the one surface of the mold portion 450 may be disposed in the first and second accommodating grooves h1 and h2 formed to be spaced apart from each other on the sixth surface 406 of the body B. Both end portions of the coil portion 430 may pass through the support portion 410 of the mold portion 450, and be exposed from one surface of the support portion 410. Although not specifically illustrated, since both end portions of the coil portion 430 have a thickness, equal to a thickness of the coil portion 430, the coil portion 430 may have a shape protruding from the one surface of the support portion 410 by an amount corresponding to the thickness of the coil portion 430. Since the protruding end portion may also be polished, in a process of polishing an opening of a plating resist for forming the external electrodes 470 and 480 to be described later, an end portion of the coil portion 430 exposed from the one surface of the support portion 410 may be substantially smaller than the thickness of the coil portion 430.

The external electrodes 470 and 480 may be spaced apart from each other on one surface of the body B, e.g., the sixth surface 406. Specifically, the external electrodes 470 and 480 may be disposed on one surface of the mold portion 450 to be spaced apart from each other, respectively, and may be connected to both end portions of the coil portion 430 disposed in the first and second accommodating grooves h1 and h2, respectively. Both end portions of the coil portion 430 may be disposed along lower surfaces of the first and second accommodating grooves h1 and h2, and the external electrodes 470 and 480 may be applied along both end portions of the coil portion 430, such that the external electrodes may be formed to correspond to shapes of the first and second accommodating grooves h1 and h2. As an example, the external electrodes 470 and 480 may be formed by coating a conductive resin including a conductive particle such as silver (Ag) on the first and second accommodating grooves h1 and h2. The external electrodes 470 and 480 may be formed of a conductive material such as copper (Cu), aluminum (Al), silver (Ag), tin (Sn), gold (Au), nickel (Ni), lead (Pb), chromium (Cr), titanium (Ti), or alloys thereof, but the present disclosure is not limited thereto. The external electrodes 470 and 480 may be formed in a single-layer structure or a multilayer structure. According to the present embodiment, the external electrodes 470 and 480 may include a first layer contacting and connected to both end portions of the coil portion 430, and a second layer covering the first layer. As an example, the first layer may be formed of a conductive resin including silver (Ag) particle, but the present disclosure is not limited thereto, and may be formed of a plating layer including copper (Cu). Although not specifically illustrated, the second layer may be disposed on the first layer to cover the first layer. The second layer may include nickel (Ni) and/or tin (Sn). The second layer may be formed by electroplating, but the present disclosure is not limited thereto.

The magnetic component 400 according to the present embodiment may further include an insulating layer 490 surrounding a surface of the coil portion 430. A process of forming the insulating layer 490 is not limited, but may be formed by, for example, chemical vapor deposition of parylene resin or the like on the surface of the coil portion 430, and may be formed by a known method such as screen printing method, photoresist (PR) exposure, a process through development, spray application, dipping process, or the like. The insulating layer 490 is not particularly limited as long as it may be formed as a thin film, but may include, for example, photoresist (PR), an epoxy-based resin, or the like.

Although not illustrated, the magnetic component 400 according to the present embodiment further may include an additional insulating layer in a region of the sixth surface 406 of the body B, except for a region in which the external electrodes 470 and 480 are disposed. The additional insulating layer may be used as a plating resist in forming the external electrodes 470 and 480 by electroplating, but the present disclosure is not limited thereto. In addition, the additional insulating layer may be disposed on at least a portion of the first to fifth surfaces 401, 402, 403, 404, and 405 of the body B, to prevent an electrical short circuit between other electronic components and the external electrodes 470 and 480. Although it is illustrated that the through-grooves H1 and H2 pass through the mold portion 450 in the mold portion 450, this is merely illustrative. For example, as a modified embodiment of the present embodiment, the through-grooves H1 and H2 may be formed on a side surface of the mold portion 450, and may communicate with the first and second accommodating grooves h1 and h2, disposed on one surface of the mold portion 450. In this case, both end portions of the coil portion 430 may be disposed along the side surface of the mold portion 450 and the one surface of the mold portion 450. In addition, although the magnetic component 400 includes the magnetic particle of FIG. 10 in the present embodiment, the magnetic component 400 may alternatively include the magnetic particle of FIG. 8, and this may be applied to the following embodiments in a similar manner.

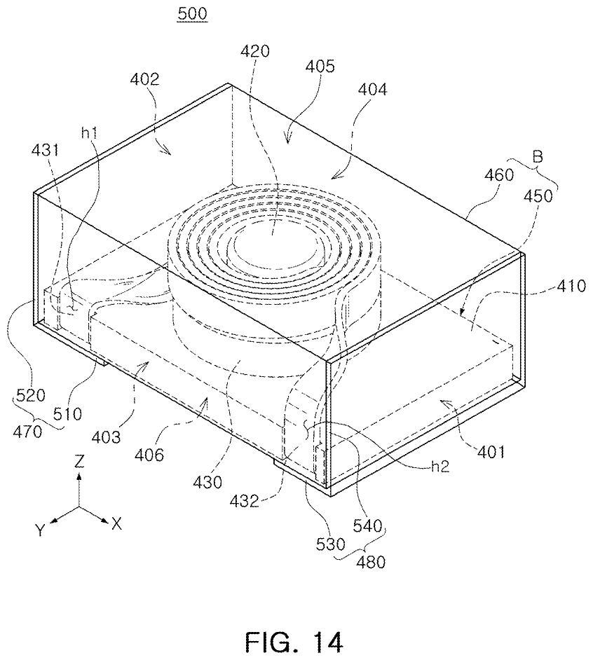

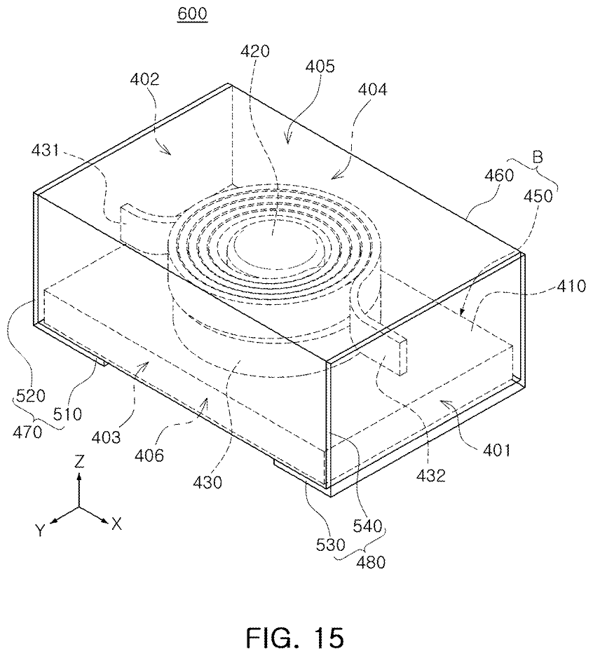

Magnetic components according to the modified embodiment will be described with reference to FIGS. 14 and 15. First, in an embodiment of FIG. 14, a magnetic component 500 may be different from the previous embodiment in view of a manner in which a coil portion 430 is drawn out of a body B, and other overlapping configurations will be omitted. In the present embodiment, a support portion 410 of the magnetic component 500 may include first and second accommodating grooves h1 and h2 formed to have shapes corresponding to shapes of first and second lead-out portions 431 and 432, to accommodate the first and second lead-out portions 431 and 432 of a winding coil 430. The first and second accommodating grooves h1 and h2 may be respectively formed in a thickness direction (a T direction) on one side surface of the support portion 410, and may be formed to extend from the other surface 406 of the support portion 410 in a second direction (a Y-direction). The first and second accommodating grooves h1 and h2 may be disposed parallel to each other in a first direction (an X-direction). Therefore, when a magnetic material is included in a cover portion 460, a component, identical to the magnetic material of the cover portion 460, may be disposed in the first and second accommodating grooves h1 and h2. The first and second lead-out portions 431 and 432 may be accommodated along the first and second accommodating grooves h1 and h2 of the support portion 410, respectively, and one end thereof may be connected to the winding part, and the other end thereof may be exposed from a sixth surface 406 of the body B and may be respectively connected to first and second external electrodes 470 and 480. In this case, the first external electrode 470 may include a region 510 covering the sixth surface 406 of the body B and a region 520 covering a second surface 402 of the body B. The second external electrode 480 may include a region 530 covering the sixth surface 406 of the body B and a region 540 covering the first surface 401.

Next, in an embodiment of FIG. 15, a separate accommodating groove may not be formed in a support portion 410 of a magnetic component 600. Therefore, first and second lead-out portions 431 and 432 of a winding coil 430 may be exposed from an opposite side surface of a body B, respectively. For example, the first lead-out portion 431 may be exposed from a second surface 402 of the body B, and the second lead-out portion 432 may be exposed from a first surface 401 of the body B, to be connected to first and second external electrodes 470 and 480, respectively.

In a magnetic particle according to an embodiment of the present disclosure, coercive force may be effectively reduced, and thus loss of a magnetic component employing the same may be reduced to increase efficiency.

While example embodiments have been illustrated and described above, it will be apparent to those skilled in the art that modifications and variations could be made without departing from the scope of the present disclosure as defined by the appended claims.

What is claimed is:

1. A magnetic particle comprising:
a magnetic metal particle having a plurality of phases,
wherein the plurality of phases include an Fe-based phase and an Fe₃O₄ phase,
wherein an area ratio of the Fe₃O₄ phase in which the Fe₃O₄ phase occupies in the plurality of phases is less than 50%.

2. The magnetic particle of claim 1, wherein the Fe-based phase comprises a single crystalline zone.

3. The magnetic particle of claim 2, wherein the Fe-based phase has a polycrystalline structure in which the single crystalline zone is provided in plural.

4. The magnetic particle of claim 2, wherein the single crystalline zone comprises at least one selected from the group consisting of an Fe(001) phase, an Fe(011) phase, an Fe(002) phase, an Fe(101) phase, an Fe(111) phase, and an Fe(224) phase.

5. The magnetic particle of claim 1, wherein in addition to Fe, the Fe-based phase comprises a metal including Si and Cr.

6. The magnetic particle of claim 1, wherein the plurality of phases comprise an amorphous phase.

7. The magnetic particle of claim 6, wherein the amorphous phase comprises at least one of Fe-based metal or Fe-based metal oxide.

8. The magnetic particle of claim 1, wherein the Fe₃O₄ phase comprises a single crystalline zone.

9. The magnetic particle of claim 8, wherein the single crystalline zone comprises at least one selected from the group consisting of an Fe₃O₄ (022) phase, an Fe₃O₄ (113) phase, an Fe₃O₄ (311) phase, and an Fe₃O₄ (111) phase.

10. The magnetic particle of claim 1, wherein an area ratio of the Fe₃O₄ phase in the magnetic metal particle is 19% to 42.3%.

11. The magnetic particle of claim 1, wherein a ratio of the Fe₃O₄ phase present on a surface of the magnetic metal particle is less than 70%.

12. The magnetic particle of claim 1, wherein at least a portion of the Fe₃O₄ phase is present in a central portion of a cross-section passing through a center of the magnetic metal particle.

13. The magnetic particle of claim 1, further comprising an oxide film disposed on a surface of the magnetic metal particle.

14. The magnetic particle of claim 13, wherein the oxide film comprises a crystalline zone.

15. The magnetic particle of claim 14, wherein the crystalline zone comprises an Fe₃O₄ component.

16. The magnetic particle of claim 15, wherein the Fe₃O₄ component of the crystalline zone has an orientation structure different from that of the Fe₃O₄ phase.

17. The magnetic particle of claim 1, wherein a diameter measured in a cross-section including a center of the magnetic particle is 10 to 900 nm.

18. A magnetic particle comprising:
a magnetic metal particle having a plurality of phases,
wherein the plurality of phases include an Fe-based phase and an Fe₃O₄ phase,
wherein a ratio of the Fe₃O₄ phase present on a surface of the magnetic metal particle is less than 70%.

19. The magnetic particle of claim 18, wherein an area ratio of the Fe₃O₄ phase in the magnetic metal particle is 19% to 42.3%.

20. The magnetic particle of claim 18, wherein at least a portion of the Fe₃O₄ phase is present in a central portion of a cross-section passing through a center of the magnetic metal particle.

21. A magnetic component comprising:
a body containing a plurality of magnetic particles,
wherein at least one magnetic particle, among the plurality of magnetic particles, includes the magnetic particle of claim 18.

22. The magnetic component of claim 21, further comprising a coil disposed in the body.

23. A magnetic particle comprising:
a magnetic metal particle having a plurality of phases,
wherein the plurality of phases include an amorphous phase and an Fe₃O₄ phase.

24. The magnetic particle of claim 23, wherein the plurality of phases further comprise an Fe-based single crystalline zone.

25. The magnetic particle of claim 24, wherein the plurality of phases comprise a plurality of the Fe-based single crystalline zones.

26. A magnetic component comprising:
a body containing a plurality of magnetic particles,
wherein at least one magnetic particle, among the plurality of magnetic particles, includes the magnetic particle of claim 23.

27. The magnetic component of claim 26, further comprising a coil disposed in the body.

28. A magnetic component comprising:
a body containing a plurality of magnetic particles,
wherein at least one magnetic particle, among the plurality of magnetic particles, includes a magnetic metal particle having a plurality of phases,
wherein the plurality of phases include an Fe-based phase and an Fe₃O₄ phase,
wherein an area ratio of the Fe₃O₄ phase in which the Fe₃O₄ phase occupies in the plurality of phases is less than 50%.

29. The magnetic component of claim 28, further comprising a coil disposed in the body.

30. The magnetic component of claim 28, wherein, a magnetic particle including a magnetic metal particle having a plurality of phases, among the plurality of magnetic particles, is referred to as a composite particle,
the composite particle is included as a plurality of composite particles in the body, and
D50 of a diameter of each of the plurality of composite particles is 100 to 300 nm.

31. A magnetic component comprising:
a body containing a plurality of magnetic particles,
wherein the plurality of magnetic particles include first to third magnetic particles including first to third magnetic metal particles, respectively,
wherein the first magnetic particle has a diameter in a first diameter range, the second magnetic particle has a diameter in a second diameter range, smaller than the first diameter range, and the third magnetic particle has a diameter in a third diameter range, smaller than the second diameter range, and
the third magnetic metal particle includes an Fe-based phase and an Fe₃O₄ phase.

32. The magnetic component of claim 31, wherein the diameters of the first to third magnetic particles are diameters measured in a cross-section of the body.

33. The magnetic component of claim 31, wherein the first diameter range is 5 to 61 μm,
the second diameter range is 0.6 to 4.5 μm, and
the third diameter range is 10 to 900 nm.

34. The magnetic component of claim 33, wherein, in the cross-section of the body, relative to a sum of areas of the first to third magnetic particles, an area ratio of the first magnetic particle is 50 to 90%, and an area ratio of the third magnetic particle is 7.6 to 16%.

35. The magnetic component of claim 31, wherein the second and third magnetic metal particles comprise different materials.

36. The magnetic component of claim 31, wherein the first diameter range is 5 to 61 μm,
the second diameter range is 0.9 to 4.5 μm, and
the third diameter range is 10 to 800 nm.

37. The magnetic component of claim 31, further comprising a coil disposed in the body.

38. A magnetic particle comprising:
a magnetic metal particle containing Fe and having a plurality of phases; and
an oxide film containing Fe to cover the magnetic metal particle.

39. The magnetic particle of claim 38, wherein the oxide film includes a crystalline zone having a crystal orientation different from that of a crystal phase among the plurality of phases of the magnetic metal particle.

40. The magnetic particle of claim 39, wherein the crystalline zone includes an Fe₃O₄ component.

41. The magnetic particle of claim 38, wherein a thickness of the oxide film is 5 to 20 nm.

42. The magnetic particle of claim 38, wherein the oxide film surrounds the magnetic metal particle.

43. A magnetic component comprising:
a body containing a plurality of magnetic particles,
wherein at least one magnetic particle, among the plurality of magnetic particles, includes the magnetic particle of claim 38.

44. The magnetic component of claim 43, further comprising a coil disposed in the body.
